(19) United States
(12) Patent Application Publication
(10) Pub. No.: US 2007/0164131 A1
(43) Pub. Date: Jul. 19, 2007

(54) Process and apparatus for producing structural elements

(75) Inventors: Ingo Kleba, Aachen (DE); Hans-Guido Wirtz, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG & Hennecke GmbH

(21) Appl. No.: 11/635,243

(22) Filed: Dec. 7, 2006

(30) Foreign Application Priority Data
Dec. 15, 2005 (DE) 102005059890.0

(51) Int. Cl. B05D 3/12; B05B 7/04

(52) U.S. Cl. 239/433; 427/355; 427/407.1; 427/447; 427/209; 239/398; 239/418

(57) ABSTRACT

Structural elements are produced by applying a polyurethane (PUR)-forming reactive mixture and solid particles to a fibrous web in amounts such that the particle density is from 0.01 to 10.0 g of solid particles/cm² of coated fibrous web surface being set, and then pressing to harden the fibrous web coated with the not-fully-cured polyurethane reactive mixture containing solid particles.

### BACKGROUND OF THE INVENTION

The invention relates to a process and an apparatus for producing structural elements by applying a polyurethane (PUR) reactive mixture and solid particles to a fibrous web such that the density of solid particles is from 0.01 to 10.0 g of solid particles/cm² of coated fibrous web surface, and the fibrous web coated with the not-fully-cured polyurethane reactive mixture and containing solid particles is then pressed and hardens.

To save energy, the motor industry has been seeking to produce lighter cars for many years. For this reason metal is being increasingly replaced by plastics. In this context, the plastic material polyurethane has special importance.

The replacement of metal by plastics must be done in such a way that no adverse effects are produced. For example, the required strength values must be maintained. For this reason, plastic components must be reinforced with high-strength fibres.

The first applications involved mixing milled short glass fibers with the polyurethane reactive plastics material in order to achieve the required strength values. However, this is a high-cost process because of the complex and costly plant components and the high consumption of material. In addition, the weight saving was comparatively small.

In more recent processes, lightweight fibrous webs serving as the carrier substrate are sprayed on both sides with reactive plastics material which cures during the subsequent pressing operation. In this process, however, only sufficient reactive plastics material is used to wet the individual fibers and bond them to one another while leaving cavities between the fibers. In this way lightweight, high-strength structural elements are produced. The term “structural elements” should be understood to mean molded bodies or components, or individual elements of assemblies of components, which are used, for example, in motor vehicle construction and other applications.

In further developments, multilayer substrates or so-called sandwich structures, for example, fibrous web/spacer element/fibrous web structures are sprayed with reactive plastics material, honeycomb cores being used, for example, as spacer elements. In this process, too, the reactive plastic material is used only to bond the entire compound (composite), but not to fill the cavities between the fibers and the spacer element. After the pressing and curing process such a compound not only has high strength but, because of the honeycomb core, is especially light.

However, a disadvantage of these new structural elements based on the above-mentioned compounds is the irregular surface texture of the pressed and bonded fibrous webs, so that it has been necessary up to now to conceal the surface with relatively thick films or textiles, representing a considerable increase in technical complexity and cost, and reducing the weight advantage.

It would be possible in principle to improve the surface quality by increasing the quantity of PUR added, but in that case the proportion of PUR would have to be increased to such an extent that the weight advantage would be entirely lost, since more PUR would flow into the honeycomb core.

A further problem, particularly in the case of three-dimensional structural elements, is caused by the pressing process, by which the fibrous web is distorted at individual points, so that the wall thicknesses required for design reasons cannot be maintained in these “stress zones”.

Another problem arises in structural elements having a honeycomb core because the core is crushed during the pressing process, especially at the edges. This has the results that the edges of a structural element with honeycomb core are not cleanly formed and too much reactive plastic material flows into this area, leading to increased weight at particular points and therefore to an uneven weight distribution.

### SUMMARY OF THE INVENTION

It is therefore the object of the present invention to provide a simple process and a simple apparatus for producing high-strength, lightweight structural elements having a homogeneous surface while forming the desired contours using fibrous web, without the need for additional finishing or covering operations.

This and other objects which will be apparent to those skilled in the art are accomplished by applying powdery particles to a reactive polyurethane-forming mixture at a specified density before that reactive mixture has completely reacted with apparatus such as those described more fully below.

### BRIEF DESCRIPTION OF THE DRAWINGS

FIG. 1 is a schematic illustration of an apparatus suitable for sprayed application of PUR and solid particles to a three-layer substrate;

FIG. 2 illustrates the three-layer substrate to which PUR and solid particles have been applied during pressing and curing.

FIG. 3 illustrates a three-layer structural element produced in accordance with the process of the present invention.

FIG. 4 is a schematic representation of a single-layer substrate during the spray application of PUR and solid particles to that substrate.

FIG. 5 is a schematic representation of a single layer substrate to which PUR and solid particles have been applied prior to the pressing and curing process.

FIG. 6 is a schematic representation of a single layer structural element produced by the process of the present invention.

FIG. 7 is a schematic representation of a spray head for spraying PUR reactive mixture charged with solid particles to a substrate.

FIG. 8 is a schematic representation of a continuous plant for producing structural elements in accordance with the present invention.

### DETAILED DESCRIPTION OF THE INVENTION

The present invention relates to a process for producing structural elements in which a polyurethane (PUR)-forming reactive mixture and solid particles are applied to a fibrous web, at a density of from 0.01 to 10.0 g of solid particles/cm² of coated fibrous web surface being set. The fibrous web coated with the not-fully-cured polyurethane-forming reactive mixture and solid particles is then pressed and hardened.

The PUR-forming reactive mixture is preferably sprayed on to the fibrous web surface. In the case of structural elements made up of only a fibrous web, polyurethane and solid particles, the PUR-forming reactive mixture and solid particles are preferably applied to both sides of the fibrous web. In the case of multilayer structural elements having, for example, a fibrous web/spacer element/fibrous web structure, the PUR-forming reactive mixture and the solid particles are preferably applied to both outer faces of the multilayer substrate.

The process of the present invention may be carried out either continuously or discontinuously. During the process, the polyurethane-forming reactive mixture forms a bond with the fibrous web and the solid particles after curing.

In the process of the present invention, the solid particles are wetted substantially on all sides with polyurethane-forming reactive mixture, leading to a significant increase in the viscosity and thixotropy of the polyurethane-forming reactive mixture. This in turn has the effect that the polyurethane-forming reactive mixture can be applied to oblique or even vertical surfaces without running.

An important effect in this context is that, because of the viscosity increase and thixotropy, the mixture penetrates the fibrous web more slowly, so that the proportion of solid can be used to adjust the amount of polyurethane-forming reactive mixture which remains on the surface and the amount which penetrates the interior of the compound component. This additional degree of freedom makes it possible to achieve the optimal compromise between sufficient bonding of the compound, low weight and good surface quality of the structural element.

The filler also has a positive effect on the microstructure of the surface of the structural element. The flow behavior of the pure polyurethane-forming reactive mixture through the substrate, which contains at least one fibrous web, is comparable to the flow of a liquid through a bulk filling. Gravity or the pressure difference caused by closing of the tool causes the liquid to flow through the bulk filling (the fibrous web).

Because of the fibrous texture the liquid does not form a smooth surface to the atmosphere. Instead, as a result of the interaction of boundary and surface tensions with respect to the fibrous material and the air, and of the flow behavior, the polyurethane-forming reactive mixture forms an inhomogeneous surface. Air inclusions are thereby formed between the fibers.

The fine-grained filler wetted with the polyurethane-forming reactive mixture can better fill these spaces on the surface, thereby significantly improving the microstructure on the surface. This is achieved by increased flow resistance resulting from the higher viscosity and because of the fracturing of the boundary face between reactive mixture, air and fibers by the solid particles. The tendency to form a curved surface between the fibers on the surface through boundary layer forces is significantly reduced.

A particular effect achieved with the process of the present invention during the forming process in a press, is that although the PUR-forming reactive mixture penetrates the at least one fibrous web and wets all the fibers, which then adhere to one another, the solid particles wetted with PUR-forming reactive mixture are partially filtered out by the at least one fibrous web and are caught on the surface of the at least one fibrous web, filling all the gaps between the individual fibers. In this way, high-strength, lightweight structural elements having a high-quality, homogeneous surface and correct formation of the desired contours are produced without the need for additional finishing or covering operations.

It is also possible to use a substrate including two fibrous webs in the process of the present invention. In this case a spacer element, for example, a honeycomb core, may preferably be arranged between the two fibrous webs.

Also in the case of a multilayer substrate having, for example, a fibrous web/spacer element/fibrous web structure, the PUR-forming reactive mixture and the solid particles are preferably applied to both sides, that is, on the outer face of each fibrous web. In this case a viscosity increase and thixotroping of the PUR reactive mixture are also brought about by the solid particles. In the subsequent reaction and molding process in a press, the thixotropic PUR-forming reactive mixture penetrates the fibrous webs and wets the fibrous webs and the spacer element which adhere to one another and produce a composite. A portion of the solid particles wetted with PUR-forming reactive mixture is filtered out and caught on the outer faces of the fibrous webs, so that, as a result of the spacer element, preferably the honeycomb core, especially lightweight and high-strength structural elements having a high-quality, homogenous surface are produced.

In the case of this embodiment, too, the effect that the PUR-forming reactive mixture penetrates the fibrous web more slowly, and enters the honeycomb core behind the fibrous web more slowly, because of its increased viscosity and thixotropy also occurs, so that the quantity of reactive plastic material which remains on the surface and the quantity which penetrates the interior of the composite component can be adjusted via the proportion of solid material. As a result of this additional degree of freedom, the optimal compromise between adequate bonding of the composite, low component weight and good surface quality of the component can be achieved.

It is also possible to apply the solid particles in different quantities to different zones of the substrate, so that the solid particles are present in different densities (in g of solid particles/cm² of sprayed fibrous web surface) in different zones. This can be achieved, for example, by varying the content of solid particles in the PUR-forming reactive mixture used, for example, by varying the quantity of solid particles metered in a continuous admixing of solid particles to the PUR-forming reactive mixture, or by using isocyanate or polyol components having different solid contents. However, this can also be achieved by applying different quantities of solid particles to the sprayed-on layer of PUR-forming reactive mixture in different zones of the substrate.

This is especially advantageous in the case of three-dimensional structural elements, because the fibrous webs are partially distorted during the pressing process of such three-dimensional structural elements, so that in some cases the required wall thicknesses are not maintained in these distorted zones (“stress zones”). By increasing the quantities of solid particles in such “stress zones” the desired wall thicknesses can be achieved here, too.

In the case of composite elements having honeycomb cores it is advantageous to increase the proportion of solid particles, in particular at the edges or in zones with abrupt contour changes, in order to partially compensate for the rupturing of honeycomb cells in these zones caused by the pressing process.

The solid particles preferably have a bulk density according to DIN EN ISO60 of 0.1 g/cm³ to 2 g/cm³. In general, it will be attempted to use especially light solid particles in the range from 0.1 to 1.5 g/cm³, especially preferably from 0.1 to 1 g/cm³. However, to achieve particular effects, for example, optical metallic effects, or to improve the fire-resistant properties of the surfaces with solid flameproofing agents, or to enhance the indentation hardness of the surfaces, solid particles having higher bulk densities may be advantageous in particular cases.

In the process of the present invention, densities of solid particles on the fibrous web are set from 0.01 to 10.0 g of solid particles/cm² of sprayed fibrous web surface, preferably from 0.05 g/cm² to 5 g/cm², most preferably from 0.1 g/cm² to 1 g/cm². Densities of 0.01 g/cm² to 3 g/cm² are especially suitable for producing homogenous surfaces, and densities of from 0.5 g/cm² to 10 g/cm² are especially suitable for compensating collapsed edges and “stress zones”.

An essential parameter when implementing the process of the present invention is the ratio of the mass of solid particles to the mass of PUR-forming reactive mixture which is applied to the substrate surface. This ratio is preferably from 0.01 to 10, more preferably from 0.1 to 5, most preferably from 1 to 3. Depending on the starting viscosity of the PUR-forming reactive mixture, the ratio of mass of solid particles to mass of PUR-forming reactive mixture determines the degree of thixotropy. It determines, on the one hand, how far the PUR-forming reactive mixture penetrates the substrate and the honeycomb core and, or the other, how steeply the surface to be sprayed can be inclined to the horizontal.

In the manufacture of composite elements it is preferred to apply only enough PUR-forming reactive mixture to wet and bond to one another substantially all the fibers of the at least one fibrous web, but at the same time to leave free substantially all the cavities in the spacer element or honeycomb core. The quantity of solid particles applied is preferably adjusted so that only sufficient solid particles are applied to the fibrous web as are necessary to compensate uneven surfaces, collapsed edges or contracted stress zones. The optimum quantity of PUR-forming reactive mixture and solid particles to be applied can be readily determined by a person skilled in the art by simple tests in which different quantities of PUR-forming reactive mixture and solid particles are applied to the fibrous web or composite element.

As solid particles, particles having a granular or powdery structure with grain sizes ranging preferably from 5 μm to 500 μm are suitable. Mixtures of different grain sizes are particularly important since they make possible optimum packing densities in order to compensate the completely irregular unevenness of the surface of the fibrous webs. It has been found that powder of recycled, finely-milled PUR foam materials, in particular hard foam materials, are suitable as particle mixtures. The comminution of the cell structures produces a particle mix value of preferably from 10 to 30 (e.g., approximately 20 wt. % above 300 μm), from 30 to 50 (e.g., approximately 40 wt. % above 100 μm and below 300 μm), and of from 30-50 (e.g., approximately 40 wt. % below 100 μm, values determined by sieving).

Fibers having numerical mean lengths of preferably from 5 μm to 500 μm and a diameter-length ratio of preferably from 1.0 to 0.01 are suitable as solid particles in the process of the present invention. The micro-fibers are preferably the same material as the at least one fibrous web to be coated. This gives rise to homogenous and at the same time fibrous surface textures. Attention should then be paid to ensuring that collapsed edges, in the case of composite elements with spacer elements (e.g., honeycomb core), or contracted stress zones, are compensated, in order to achieve a correct configuration of the contours and wall thicknesses.

Solid particles in the form of flakes having numerical mean diameters (determined, for example, by microscopic analysis) of preferably from 5 μm to 500 μm, and thickness-diameter ratios of preferably from 1.0 to 0.01, are suitable as solid particles in the process of the present invention. In this way particular surface textures can be produced. Flakes of glass or mineral, for example, are suitable for increasing the indentation strength of the surface.

As solid particles, glass, mineral, metal, plastic or natural products, such as hemp or jute, may be used. As a rule, in particular solid particles which are especially light will be used. Synthetic materials are therefore preferred. To achieve special surface effects metal powders, for example, with which an optical metallic effect is possible, are especially suitable.

As solid particles, mixtures of solid particles which differ with respect to materials and/or structure and/or particle size distribution may be used in the process of the present invention. However, mixtures having the same material and structure and different mean volumetric grain sizes may also be used.

The at least one fibrous web included in a composite element advantageously contains glass, mineral, metal, plastic or natural fibers, for example, hemp or jute. Natural fibers are especially advantageous, as they have extremely high strength but, above all, are light and additionally save resources.

The application of the PUR-forming reactive mixture to the at least one fibrous web may be carried out, for example, as a film in a pouring process. However, the application of the PUR reactive mixture in a sprayed application is preferred, since wetting of the at least one fibrous web is thereby optimized. Above all, however, larger application widths and higher feed rates of the spray-mixing head are possible with spraying, so that significantly higher production outputs are possible in this way.

The solid particles are preferably introduced into the flow of PUR reactive mixture prior to spraying and are sprayed together with it on to the substrate. In this way the solid particles are optimally wetted on all sides. In addition, the desired thixotroping of the PUR-forming reactive mixture acts directly, i.e. without any time delay.

However, in particular for simple applications, it is also possible to apply the solid particles to the PUR-forming reactive mixture or to the fibrous web only after spraying or wetting of the substrate with the PUR-forming reactive mixture. This subsequent application of the solid particles preferably takes place, however, directly after the application of the PUR-forming reactive mixture, i.e. without a significant time delay, in order to ensure the required thixotroping of the PUR-forming reactive mixture within the time tolerance range.

In a preferred embodiment of the present invention, heat is applied to the composite element containing at least one fibrous web and optionally at least one spacer element and/or further elements, together with PUR-forming reactive mixture and solid particles during the pressing process. In this way, the chemical reaction can take place through thermal activation. This has the additional advantage of allowing sufficient time for the spraying or wetting process of the at least one fibrous web with PUR-forming reactive mixture while nevertheless achieving short curing times and therefore short production cycles.

The present invention also relates to a spray head for spraying polyurethane reactive mixture charged with solid particles. This spray head includes at least one mixing head, a first conduit for the solid particles having an inlet opening for a gas stream, and a second conduit for solid particles. The at least one spray-mixing head for the polyurethane-forming reactive mixture contains a spray nozzle for the polyurethane-forming reactive mixture. The at least one first conduit section for pneumatically conveying the solid particles contains an inlet opening for a gas stream and an intake fitting for the solid particles arranged substantially concentrically in the first conduit section. The center of gravity axis of the first conduit section which extends in the flow direction and the axis of the spray jet which extends in the spraying direction of the spray nozzle form an angle cc in the range from 10° to 120°. The first conduit section opens into the at least one second conduit section for pneumatically conveying the solid particles. The center of gravity axis of the first conduit section which extends in the flow direction, and the center of gravity axis which extends in the flow direction at the outlet opening of the second conduit section form an angle P in the range from 60° to 170°. The outlet opening of the second conduit section is arranged substantially in immediate proximity to the spray nozzle for the polyurethane-forming reactive mixture and is oriented substantially towards the region of the spray jet emerging from the spray nozzle for the polyurethane-forming reactive mixture.

The flow of solid particles emerging from the discharge opening of the second conduit section opens into the spray jet from the spray nozzle for the polyurethane reactive mixture. As spray-mixing heads, conventional PUR mixing heads working with the high-pressure or low-pressure mixing method may be used. Circular-jet or flat-jet spray nozzles working by means of pressure or air atomization may be adapted to these mixing heads.

The angle α is preferably in the range from 20° to 90°, most preferably from 30° to 60°.

The second conduit section may be, for example, curved. However, the second conduit section may also be connected to the first conduit section in the form, for example, of an angle. The angle β ranges from 90° to 160°, most preferably from 120° to 150°.

Through the use of the spray head for spraying PUR reactive mixture charged with solid particles, and through the curvature or angling of the first conduit section with respect to the second conduit section by the angle β, separation of the conveying air from the solid particles by virtue of centrifugal forces is achieved, so that the solid particles enter the spray jet of the PUR-forming reactive mixture and are mixed therein, while the disturbing conveying air is guided away from the spray jet of PUR-forming reactive mixture.

In a preferred embodiment, the spray head contains at least two first conduit sections connected in parallel and, preferably correspondingly, at least two second conduit sections arranged symmetrically to the spray jet emerging from the spray nozzle. In an alternative preferred embodiment, the second conduit section is configured as an annular passage around the spray nozzle in the region of the discharge from the spray nozzle. Both the second conduit section and the first conduit section may be configured as annular passages around the spray-mixing head or around the spray nozzle.

The production of structural elements from the at least one fibrous web, reactive plastic material and solid particles may take place continuously, in particular for simple elements, and also discontinuously, preferably for more complicated elements. The respective peripheral devices and presses must be equipped correspondingly to the different operating modes.

The spray head may be used, in particular, in the process of the present invention.

The invention is explained in more detail below with reference to the Drawings.

FIG. 1 shows schematically the sprayed application of PUR-forming reactive mixture and solid particles to a three-layer substrate 1, made up of two fibrous webs 2a and 2b, for example, of jute fibers, and a spacer element, for example, a honeycomb core 3, arranged between those webs. The free surfaces of the two fibrous webs 2a and 2b are each coated with PUR-forming reactive mixture using respective spray-mixing heads 4a, 4b. Directly thereafter powdery solid particles, for example, of milled recycled polyurethane, are applied to the layers 6a, 6b of PUR-forming reactive mixture already applied, by means of respective separately-arranged application devices 5a, 5b. The arrows 50a, 50b show the direction of movement of the application elements 4a, 4b, 5a and 5b.

The process operations preceding the spraying process, such as cutting of the fibrous webs 2a and 2b and the honeycomb core 3 and the placing together of the three layers to form a substrate, are not represented in FIG. 1.

These preliminary process operations may be carried out with robotic devices or manually. The substrate thus prepared is normally clamped in a frame (not shown in FIG. 1). This may take place automatically or manually. The spray-mixing heads 4a, 4b for the PUR-forming reactive mixture and the application elements 5a, 5b for the solid particles are then moved along the substrate and the substrate is sprayed with PUR-forming reactive mixture and directly afterwards with solid particles. However, it is also possible to move the frame with the substrate clamped therein past fixed spraying elements.

In a further embodiment, not shown in FIG. 1, only one spray-mixing head for the PUR-forming reactive mixture and only one application device for solid particles are used. The mixing head and application device may be moved from one side of the substrate to the other. In the case of fixed mixhead and application device, the substrate may be rotated after one side has been coated in order to spray the other side.

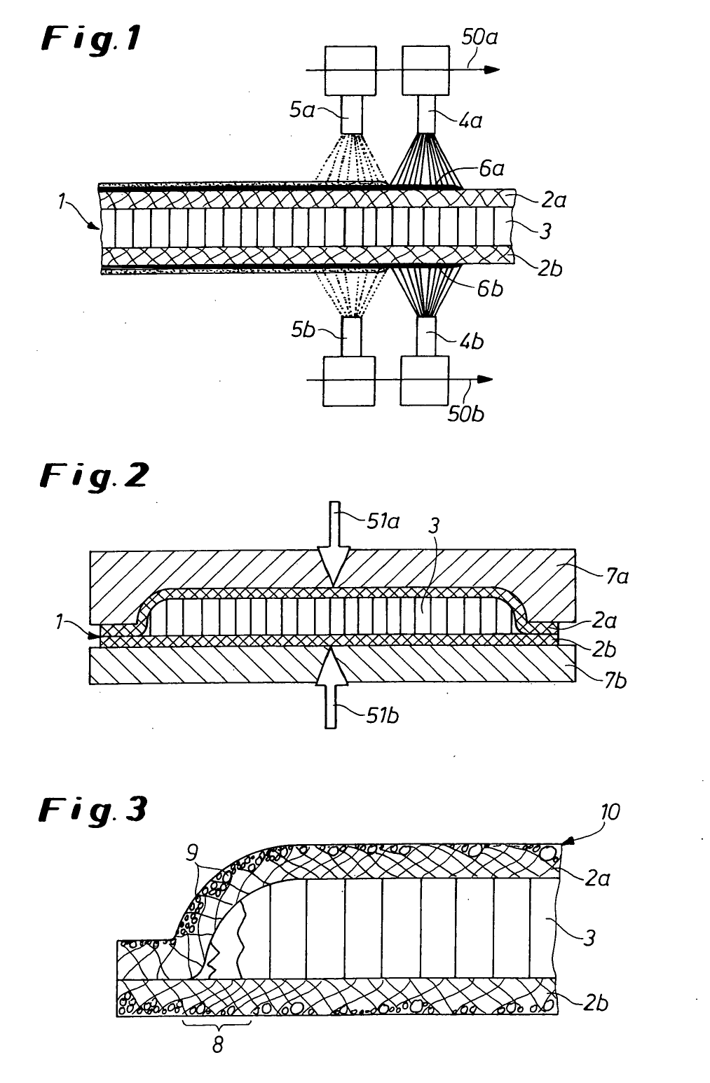

FIG. 2 shows the multilayer substrate 1 represented in FIG. 1 during the pressing and curing process, after the coating with PUR-forming reactive mixture and solid particles. Directly after the application of the PUR-forming reactive mixture and the solid particles to the substrate, the coated substrate is placed either automatically or manually on the lower tool part 7b of a press (not shown in its entirety in FIG. 2). The press is then closed (indicated by the arrows 51a, 51b), the two fibrous webs 2a, 2b being compressed. As this happens the honeycomb core 3 is substantially not compressed.

The upper tool part 7a and the lower tool part 7b are preferably heated (heating means not represented in FIG. 2), so that the chemical reaction takes place through thermal activation directly after the closing of the press. As this happens the PUR-forming reactive mixture penetrates the fibrous webs 2a, 2b and also wets the honeycomb core 3, so that the individual fibers in the fibrous webs adhere to one another and, above all, to the honeycomb core, resulting in a secure bond after curing.

The solid particles, which are wetted on all sides during the spray application and during the pressing process, remain at least partially on the surface of the fibrous web and fill the gaps between the individual fibers.

FIG. 3 shows the details of a three-layer structural element 10 which can be produced using the process shown in FIGS. 1 and 2. The three-layer structural element is made up of a honeycomb core 3 and the fibrous webs 2a and 2b, which are pressed and thereby bonded to respective sides of the honeycomb core.

In the edge portion 8, the honeycomb core 3 has collapsed during the formation of the radius in the pressing process. However, the resulting ruptures are filled by the applied solid particles 9. Above all, however, the solid particles lead to thixotropy of the PUR-forming reactive mixture, minimizing the flow of PUR-forming reactive mixture into the cavities resulting from the rupture of the honeycomb.

The surface of the structural element 10 is completely smooth as a result of the solid particles 9 intercalated between the individual fibers and wetted with polyurethane.

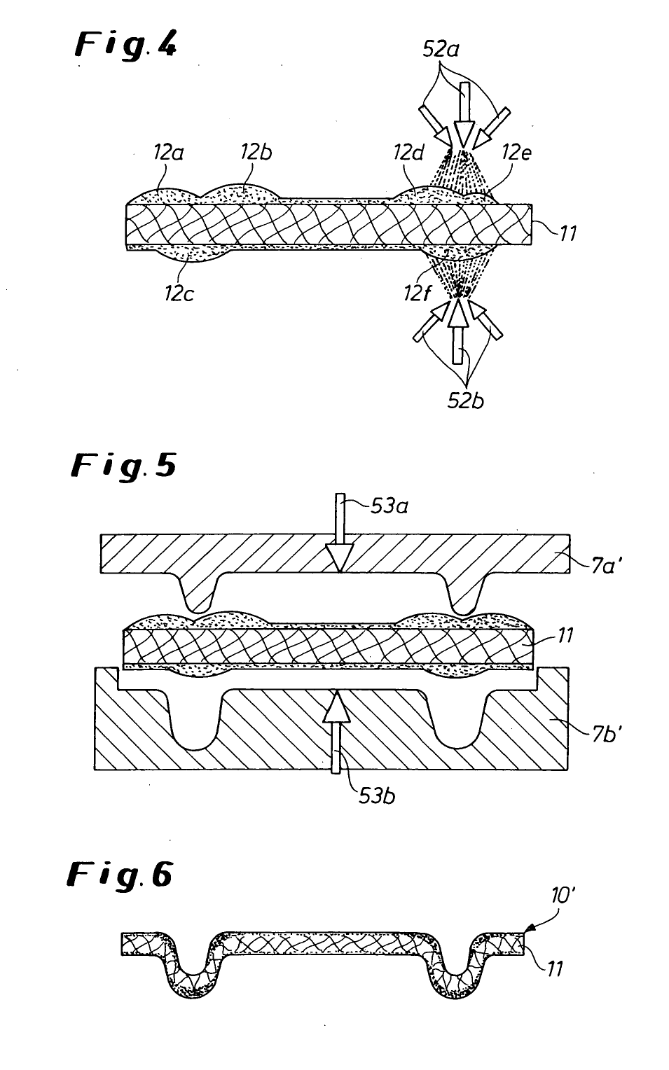

FIG. 4 is a schematic representation of a single-layer substrate during the spray application. PUR-forming reactive mixture and solid particles are applied simultaneously to both sides of the substrate, the fibrous web 11, by means of one spray head per side (indicated in FIG. 4 by arrows 52a, 52b).

At the locations where the fibrous web 11 is deformed three-dimensionally in the pressing process, distortion of the fibrous web usually occurs, so that the required wall thicknesses are not maintained in these “stress zones”. To solve this problem, the quantity of solid particles and optionally of PUR-forming reactive mixture applied at the positions 12a, 12b, 12c, 12d, 12e and 12f is increased.

FIG. 5 is a schematic representation of the substrate, the fibrous web 11, shown in FIG. 4, directly prior to the pressing and curing process. It is located between upper tool part 7a′ and lower tool part 7b′, which are then moved together by the press. The direction of movement of the press is indicated by the arrows 53a, 53b. The curing of the PUR-forming reactive mixture then occurs during the pressing process.

FIG. 6 is a schematic representation of the structural element 10′ produced from the substrate shown in FIGS. 4 and 5. During the pressing and curing process, the PUR-forming reactive mixture has penetrated the entire fibrous web 11 and wetted substantially all the fibers, so that they adhere to one another and produce a secure bond. The solid particles wetted on all sides with PUR-forming reactive mixture, which cause a significant viscosity increase and thixotroping of the PUR-forming reactive mixture, are partially filtered out by the fibrous web 11 and remain on the surface. This has the result that the entire surface of the structural element 10′ is practically completely smooth and, above all, that the required wall thicknesses are maintained in the “stress zones”.

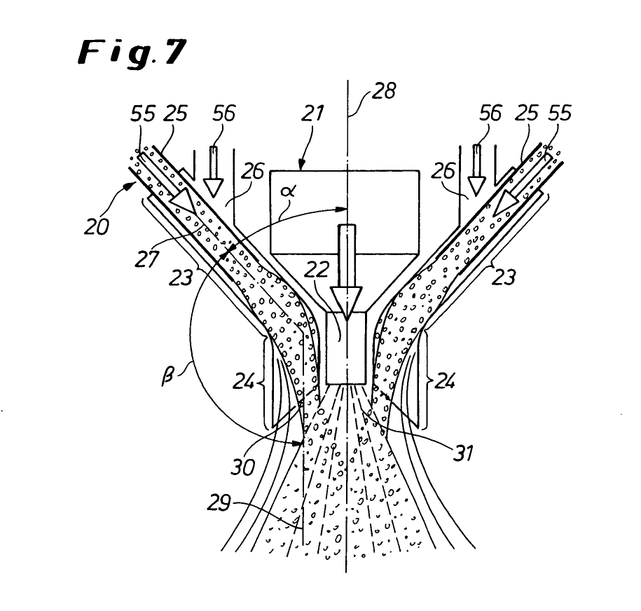

FIG. 7 is a schematic representation of a spray head 20 for spraying PUR-forming reactive mixture charged with solid particles.

The spray head 20 includes a spray-mixing head 21 for spraying PUR-forming reactive mixture through a spray nozzle 22, and a discharge device for the solid particles, composed of two conduit sections 23 operated in parallel to one another and two second conduit sections 24 hydraulically connected thereto. In the embodiment shown in FIG. 7, the first and second conduit sections 23, 24 are arranged substantially symmetrically around the axis 28 of the spray jet extending in the spraying direction of the spray nozzle 22.

The first conduit sections 23 for pneumatically conveying the solid particles each include an inlet opening 26 for a gas stream and an intake fitting 25 for the solid particles arranged substantially concentrically in the first conduit section 23. The inlet opening 26 and the intake fitting 25 are arranged in the part of the first conduit section 23 located upstream. The solid particles are aspirated by the gas stream, indicated with arrows 56, through the venturi effect. Their flow direction is indicated by arrows 55.

The center of gravity, axis 27 of the first conduit section extending in the flow direction, and the axis 28 of the spray jet extending in the spraying direction of the spray nozzle, form an angle α which in the illustrated embodiment is approximately 45°.

The two first conduit sections 23 open into respective second conduit sections 24 for pneumatically conveying the solid particles. The center of gravity axis 27 of the first conduit section 23 extending in the flow direction, and the center of gravity axis 29 extending in the flow direction at the outlet opening 30 of the second conduit section 24, include an angleβ, which in the illustrated embodiment is approximately 135°. The angle β causes the solid particles/gas stream dispersion to be deflected in the second conduit section 24.

This deflection has the result that solid particles and conveying air are separated through centrifugal forces.

The outlet openings 30 of the second conduit sections 24 are arranged substantially in direct proximity to the spray nozzle 22 for the PUR-forming reactive mixture, and are oriented substantially towards the region of the spray jet emerging from the spray nozzle 22.

The PUR-forming reactive mixture (schematically represented by an arrow in the spray-mixing head 21) emerging from the spray-mixing head 21 via the spray nozzle 22, leaves the spray nozzle 22 as a spray jet 31. As a result of the deflection of the solid particles/gas stream dispersion caused by the angle β, the solid particles separated by centrifugal forces flow on the outside path and enter the spray jet 31 of the PUR-forming reactive mixture, are mixed therein and are wetted on all sides with reactive plastic material. By contrast, the conveying air is deflected away from the spray jet 31 of reactive mixture, thus surrounding the spray jet and preventing the formation of harmful scattering aerosols. This effect is particularly efficient if the flow system for the solid particles, that is, in particular the second conduit section 24, is configured as an annular passage around the spray nozzle 22 for the reactive mixture.

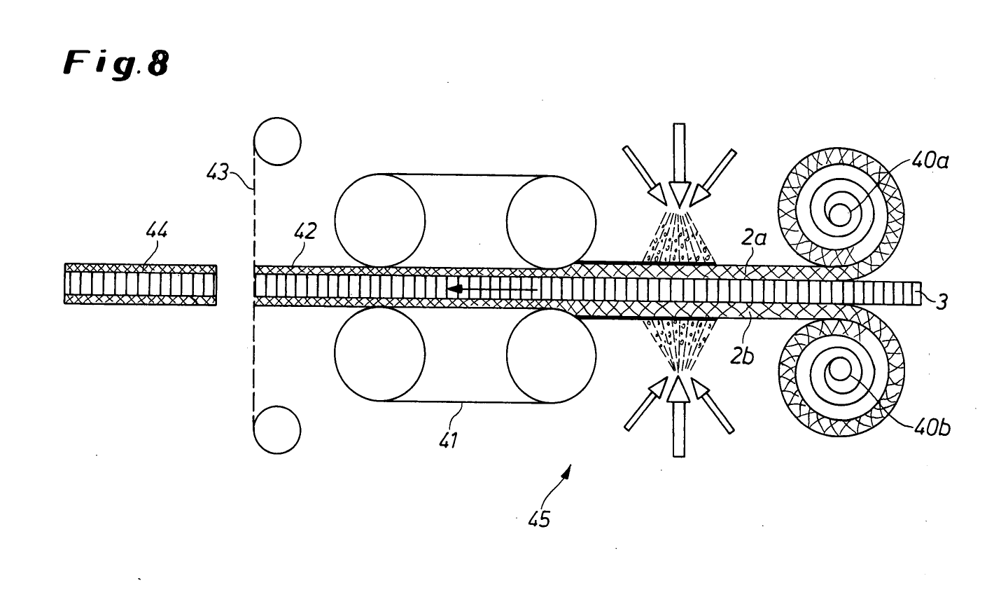

FIG. 8 is a schematic representation of a continuous plant 45 for producing three-layer structural elements 44 containing two fibrous webs 2a, 2b and a spacer element, for example, a honeycomb core 3, arranged between the fibrous webs. The fibrous webs are unwound continuously from coils 40a, 40b. Plates of honeycomb core material, honeycomb cores 3, are inserted between the two fibrous webs. This can be effected, for example, by means of robotic devices (not shown) which take over the plates from a stacking apparatus. Once the three-layer substrate has been assembled, it is sprayed on both sides with a PUR-forming reactive mixture charged with solid particles by means of spray heads. This may take place, for example, using the spray head shown in FIG. 7.

During the spraying, solid particles are introduced into the spray jet, mixed therewith and wetted on all sides with reactive plastic material.

The composite of fibrous webs, honeycomb core, PUR-forming reactive mixture and solid particles is then conveyed into the continuously operating press 41. In the press 41 only the fibrous webs 2a, 2b are compressed, without detriment to the honeycomb core 3. As this happens the PUR-forming reactive mixture penetrates the fibrous webs and wets all the fibers as well as the honeycomb core 3, so that after leaving the continuously operating press 41, that is, after the curing of the reactive mixture, a very light, high-strength structural element, for example, a panel 42, is produced, which is cut into sections of the desired length by the cutting device 43.

The solid particles cause a significant viscosity increase and thixotroping of the PUR-forming reactive mixture, so that the latter does not flow down the vertical faces of the composite. Furthermore, the thixotropy reinforces the “filtering out” of the solid particles by the fibrous webs. This has the result that the solid particles fill the gaps between the fibers on the surfaces of the fibrous webs, so that structural elements having almost completely smooth surfaces are thereby produced.

In FIG. 8 a vertical arrangement of a continuous plant for producing three-layer structural elements is represented. However, a horizontal arrangement is also possible.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for producing structural elements comprising:
a) applying a polyurethane-forming reactive mixture and solid particles to a fibrous web in a manner such that from 0.01 to 10.0 g of solid particles are present on each square centimeter of coated fibrous web surface, and
b) pressing the fibrous web coated with polyurethane-forming reactive mixture containing solid particles.

2. The process of claim 1 in which the polyurethane-forming reactive mixture and solid particles are applied to both sides of the fibrous web.

3. The process of claim 1 in which the structural element has a multilayer construction with two free surfaces formed by fibrous webs and the polyurethane-forming reactive mixture and the solid particles are applied to the two free surfaces of the fibrous webs.

4. The process of claim 3 in which the multilayer structural element is constructed from two fibrous-webs with a-spacer element-between them.

5. The process of claim 1 in which the solid particles are applied in different quantities in different zones of the fibrous web.

6. The process of claim 1 in which the solid particles have a bulk density according to DIN EN ISO 60 of from 0.1 g/cm³ to 2 g/cm³.

7. The process of claim 1 in which a ratio by weight of applied polyurethane-forming reactive mixture to applied solid particles of from 0.01 to 10 is maintained.

8. The process of claim 1 in which a ratio by weight of applied polyurethane-forming reactive mixture to applied solid particles of from 0.1 to 5 is maintained.

9. The process of claim 1 in which a ratio by weight of applied polyurethane-forming reactive mixture to applied solid particles of from 1 to 3 is maintained.

10. The process of claim 1 in which the solid particles have a granular or powdery structure and a mean volumetric grain size of from 5 μm to 500 μm.

11. The process of claim 1 in which the solid particles have a fibrous structure and the fibers have a numerical mean length of from 5 μm to 500 μm and a diameter-length ratio of from 1.0 to 0.01.

12. The process of claim 1 in which the solid particles have substantially the form of flakes having numerical mean diameters of from 5 μm to 500 μm and thickness-diameter ratios of from 1.0 to 0.01.

13. The process of claim 1 in which the solid particles are glass, mineral, metal, plastic, and/or natural products.

14. The process of claim 1 in which a mixture of different solid particles are used.

15. The process of claim 1 in which the fibrous web contains glass, mineral, metal, plastic or natural fibers.

16. The process of claim 1 in which the polyurethane-forming reactive mixture is applied by spraying.

17. The process of claim 16 in which the solid particles are introduced into a spray jet of polyurethane-forming reactive mixture during the spraying.

18. The process of claim 1 in which the solid particles are applied to the layer of polyurethane-forming reactive mixture immediately after the polyurethane-forming reactive mixture has been applied to the fibrous web.

19. The process of claim 1 in which heat is applied during the pressing process.

20. A spray head for spraying polyurethane-forming reactive mixture charged with solid particles, comprising
a) at least one spray-mixing head for the polyurethane-forming reactive mixture containing a spray nozzle for the polyurethane-forming reactive mixture,
b) at least one first conduit section for pneumatically conveying the solid particles comprising
(1) an inlet opening for a gas stream and
(2) an intake fitting for the solid particles arranged substantially concentrically in the first conduit section, having a center of gravity axis of the first conduit section extending in the particles' flow direction and a spray jet axis extending in the spray nozzle's direction of spray which form an angle a in the range of from 10° to 120°, and
c) at least one second conduit section for pneumatically conveying the solid particles, into which the first conduit section opens which second conduit section has an outlet opening arranged in proximity to the spray nozzle for the polyurethane-forming reactive mixture and is oriented towards the spray nozzle's emerging jet spray of polyurethane-forming reactive mixture with the first conduit section's center of gravity axis extending in the flow direction, and the second conduit's outlet opening center of gravity axis extending in the flow direction forming an angle β in the range from 60° to 170°.

21. The spray head of claim 20 in which the spray head comprises at least two first conduit sections and at least two second conduit sections into each of which a respective first conduit section opens with the first conduit sections and the second conduit sections being arranged substantially symmetrically around the axis of the spray nozzle's jet spray extending in the spraying direction.

22. The spray head of claim 20 in which the second conduit section is configured as an annular passage around the spray nozzle in the region of the discharge from the spray nozzle.
